(19) United States
(12) Patent Application Publication
(10) Pub. No.: US 2016/0281872 A1
(43) Pub. Date: Sep. 29, 2016

(54) PRESSURE REGULATING VALVE

(71) Applicant: AISAN KOGYO KABUSHIKI KAISHA, Obu-shi (JP)

(72) Inventors: Masahiro KOBAYASHI, Toyohashi-shi (JP); Hideyuki FUKUDA, Nagoya-shi (JP); Katsuyuki HATA, Nagoya-shi (JP); Kazuhiro NAKAMURA, Ichinomiya-shi (JP)

(73) Assignee: AISAN KOGYO KABUSHIKI KAISHA, Obu-shi (JP)

(21) Appl. No.: 15/070,648

(22) Filed: Mar. 15, 2016

(30) Foreign Application Priority Data
Mar. 26, 2015 (JP) 2015-063743

(51) Int. Cl. F16K 17/12; F16K 1/14

(52) U.S. Cl. CPC F16K 17/12; F16K 1/14

(57) ABSTRACT

A pressure regulating valve includes a piston in a pressure regulating chamber, a valve element axially movable together with the piston, a valve chamber in which an end portion of the valve element is placed, a resinous valve seat which the valve element is brought into contact with or separated from, a coil spring urging the piston in a direction to move the valve element away from the valve seat, and a body member accommodating the valve element and the valve seat. The valve element has an axially extending hollow cylindrical shape. When moved away from the valve seat, the valve element allows communication between the valve chamber and the pressure regulating chamber. The valve seat is arranged to be axially movable. An adjusting screw is provided to move the valve seat for adjusting a contact position with the valve element from outside.

### CROSS-REFERENCE TO RELATED APPLICATIONS

This application is based upon and claims the benefit of priority from the prior Japanese Patent Application No. 2015-063743, filed Mar. 26, 2015, the entire contents of which are incorporated herein by reference.

### BACKGROUND OF THE INVENTION

1. Field of the Invention

The present invention relates to a pressure regulating valve for regulating the pressure of a high-pressure gas fuel to a desired pressure by pressure reduction.

2. Related Art

Conventionally, there is a pressure regulating valve for regulating the pressure of gas fuel, including a valve element movable in an axial direction and a valve seat member with which the valve element is brought into or out of contact. This pressure regulating valve is configured such that an opening formed in a body member accommodating the valve element and the valve seat member is closed with a lid member provided with a sealing member. This type of pressure regulating valve is for example designed such that the valve seat member is fitted in a recess formed in the lid member, such a lid member is assembled to the body member in such a manner that screw threads formed in an outer wall of the lid member are screwed together with screw grooves formed in an inner wall of the body member. The lid member is moved (rotated) to adjust the position of the valve seat member to set a pressure regulating value (see Patent Document 1).

### RELATED ART DOCUMENTS

### Patent Documents

Patent Document 1: Japanese unexamined patent application publication No. 60-54025(1985)

### SUMMARY OF INVENTION

### Problems to be Solved by the Invention

In the foregoing pressure regulating valve, however, when the pressure regulating value is to be set, the lid member in which the valve seat member is fitted has to be moved (rotated) in order to adjust the position of the valve seat member. This may cause abrasion or wear and deformation of the sealing member provided to the lid member and thus lead to deterioration in sealing performance.

The present invention has been made to solve the above problems and has a purpose to provide a pressure regulating valve capable of easily setting a pressure regulating value without deteriorating sealing performance.

### Means of Solving the Problems

To achieve the above purpose, one aspect of the invention provides a pressure regulating valve including: a pressure regulating chamber; a piston placed in the pressure regulating chamber; a valve element to be movable in an axial direction together with the piston; a valve chamber in which an end portion of the valve element is placed; a valve seat member made of resin, which the valve element is brought into contact with and separated from; an urging member urging the piston in a direction to separate the valve element from the valve seat member; and a body member accommodating the valve element and the valve seat member, wherein the valve element has a hollow cylindrical shape extending in the axial direction and is configured to allow communication between the valve chamber and the pressure regulating chamber when the valve element is separated from the valve seat member, the valve seat member is arranged to be movable in the axial direction, and an adjusting member configured to move the valve seat member to adjust a contact position with the valve element from outside.

In the above pressure regulating valve, the position of the valve seat member placed movably in the axial direction is adjusted by the adjusting member while the valve chamber (or the pressure regulating chamber) is pressurized, so that a desired pressure regulating value (final pressure) is achieved in the pressure regulating chamber. Specifically, the position of the valve seat member (the contact position with the valve element) is adjusted so that the valve element comes into contact with the valve seat member at the time when the inside of the pressure regulating chamber becomes the desired pressure regulating value (final pressure). When the pressure regulating value is to be set in this manner, the position of the valve seat member can be adjusted by the adjusting member without moving (rotating) a member that holds the valve seat member. Accordingly, neither wear/abrasion nor deformation of the sealing member occurs. Thus, the position of the valve seat member can be easily adjusted to set the pressure regulating value without deteriorating the sealing performance.

### Effects of the Invention

The pressure regulating valve according to the present invention can adjust the position of a valve seat member without deteriorating sealing performance.

### BRIEF DESCRIPTION OF THE DRAWINGS

FIG. 1 is a sectional view of a pressure regulating valve in an embodiment.

### DESCRIPTION OF EMBODIMENTS

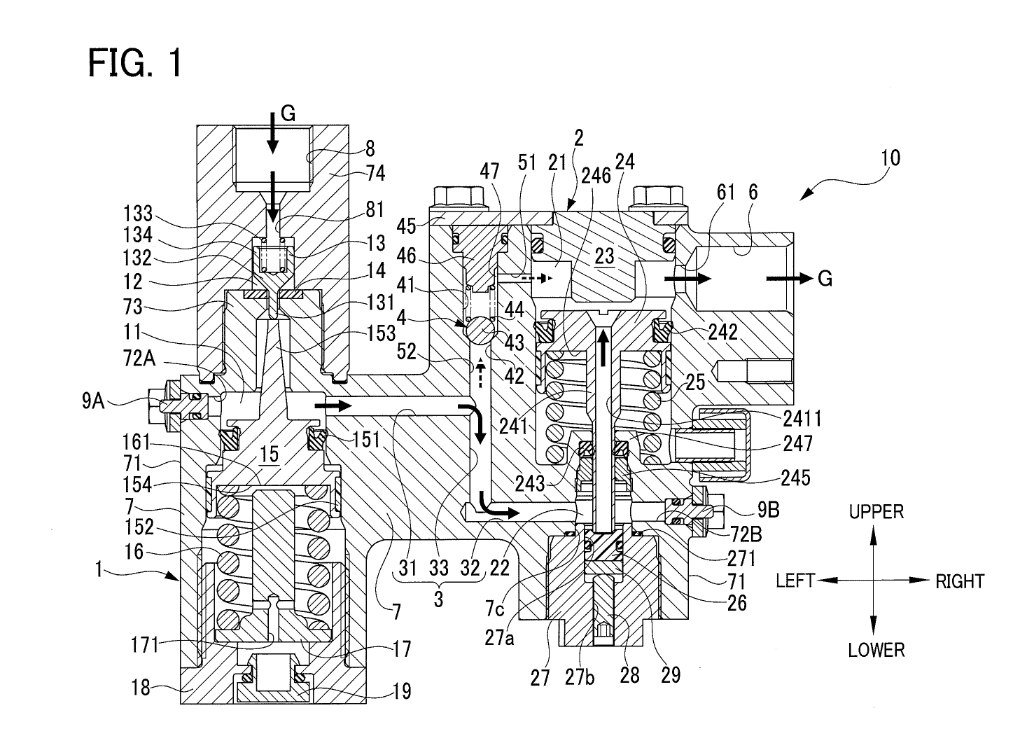

A detailed description of a preferred embodiment of a pressure regulating valve embodying the present invention will now be given referring to FIG. 1. FIG. 1 is a sectional view of the pressure regulating valve in the present embodiment.

<Whole Structure of Pressure Regulating Valve>

As shown in FIG. 1, a pressure regulating valve 10 in the present embodiment is a multistage pressure regulating valve configured to regulate or adjust the pressure of fuel gas G to a desired value by reducing this fuel gas pressure in multiple stages. The pressure regulating valve 10 includes a body member 7 provided therein with an upstream pressure regulating valve 1 located on an upstream side in a flow direction of the fuel gas G, a downstream pressure regulating valve 2 located on a downstream side, an intermediate passage 3 through which the fuel gas G will flow after pressure-reduced by the upstream pressure regulating valve 1 but before pressure-reduced by the downstream pressure regulating valve 2, and a check valve 4 connected to the intermediate passage 3. The body member 7 of the pressure regulating valve 10 is made of aluminum alloy and is formed internally with the upstream pressure regulating valve 1, the downstream pressure regulating valve 2, the intermediate passage 3, the check valve 4, and others. The upstream pressure regulating valve 1 and the downstream pressure regulating valve 2 are connected in serial to each other.

The fuel gas G is for example hydrogen gas to be supplied to a vehicle fuel cell (FC). An upstream side of the pressure regulating valve 10 is connected to a main stop valve operative to supply or stop the fuel gas G stored in a fuel tank and a downstream side of the pressure regulating valve 10 is connected to an injector for supplying the fuel gas G having been regulated to the desired pressure to the fuel cell (not shown). The fuel gas G stored in the fuel tank may be filled under pressure of about 80 to 90 MPa according to a filling facility. On the other hand, the pressure of the fuel gas G to be supplied from the pressure regulating valve 10 to the injector is reduced to a pressure of about 1.0 to 1.5 MPa.

Accordingly, the pressure regulating valve 10 reduces the pressure of the fuel gas G from about 80 to 90 MPa to about 3.0 to 2.5 MPa in the upstream pressure regulating valve 1 and then from about 3.0 to 2.5 MPa to about 1.0 to 1.5 MPa in the downstream pressure regulating valve 2.

A left upper end of the body member 7 in FIG. 1 is formed with a cylindrical protruding part 73 protruding upward. This protruding part 73 is connected with a hexagonal terminal block 74 threadedly engaged thereon from above. The terminal block 74 is formed with an inlet terminal 8 opening upward to be connected with the main stop valve. A right upper end of the body member 7 is formed with an outlet terminal 6 opening rightward to be connected with the injector.

(Upstream Pressure Regulating Valve)

The upstream pressure regulating valve 1 includes a valve chamber 12 communicated with the inlet terminal 8, a valve element 13 movable up and down in the valve chamber 12, a valve seat (a valve seat member) 14 formed at a lower end of the valve chamber 12 so that the valve element 13 will be brought into contact with and separated from the valve seat 14, a pressure regulating chamber 11 located below the valve seat 14 and allowed to communicate with the valve chamber 12 when the valve element 13 is moved upward, a piston 15 movable up and down in the pressure regulating chamber 11, a coil spring 16 urging the piston 15 upward, a holder member 17 receiving a lower end of the coil spring 16 to hold the coil spring 16, and a stopper member 18. The piston 15 is placed in a position toward which a valve spring 133 urges the valve element 13.

The terminal block 74 is internally formed with an inlet terminal passage 81 vertically extending to provide communication between the inlet terminal 8 and the valve chamber 12. Between a wall surface defining the valve chamber 12 and the valve element 13, the valve spring 133 is interposed to urge the valve element 13 downward (toward the valve seat 14). The valve element 13 includes a main body portion 134 in which one end of the valve spring 133 is mounted and a tapered portion 132 continuous to a lower end of the main body portion 134. This tapered portion 132 will be brought into contact with and separated from the valve seat 14. Under the tapered portion 132, a needle portion 131 is formed. This needle portion 131 penetrates through a through hole formed in the valve seat 14 and extends into the pressure regulating chamber 11. A lower end of the needle portion 131 abuts on a top face of an axially protruding portion 153 having a rod-like shape protruding from an upper end of a main portion of the piston 15.

On an outer peripheral surface of the main portion of the piston 15, there is fitted an annular sealing member 151 held in sliding contact with an inner peripheral surface of the pressure regulating chamber 11 to seal the pressure regulating chamber 11. This annular sealing member 151 has a lip-shaped cross-section opening upward in a V shape. A lower end of the piston 15 is formed with a spring receiving seat 154 recessed to hold the coil spring 16. The spring receiving seat 154 has a horizontal surface on which a coil end (an upper end) 161 of the coil spring 16 abuts. On an outer peripheral wall of the spring receiving seat 154, a sliding member 152 made of fluorine contained resin is mounted. The holder member 17 contacting with the lower end of the coil spring 16 is formed with a vent hole 171. The stopper member 18 is provided with a filter member 19 for filtering the outside air to be drawn into a cavity provided under the piston 15 through the vent hole 171. The pressure regulating chamber 11 is communicated with a valve chamber 22 of the downstream pressure regulating valve 2 through the intermediate passage 3 (31, 32, and 33) as described later.

(Downstream Pressure Regulating Valve)

The downstream pressure regulating valve 2 is provided with a pressure regulating chamber 21 communicated with the outlet terminal 6, a piston 24 movable up and down in the pressure regulating chamber 21, a coil spring 25 urging the piston 24 upward, the valve chamber 22 formed below the pressure regulating chamber 21, a nearly cylindrical valve element 241 extending in an axial direction of the piston 24 into the valve chamber 22, a valve seat 26 provided in a lower end of the valve chamber 22 so that a lower end of the valve element 241 will be brought into contact with and separated from the valve seat 26, a lid member 27 having the valve seat 26 fitted therein and being placed to close an opening 7c at a right lower end of the body member 7 to define the valve chamber 22. It is to be noted that the coil spring 25 is one example of an urging member of the present invention and the valve seat 26 is one example of a valve seat member. The valve chamber 22 is formed in a nearly cylindrical shape above the lid member 27. In this valve chamber 22, the lower end portion of the valve element 241 is placed. In the present embodiment, the lid member 27 is threadedly engaged in the body member 7, but also may be fixed to the body member 7 by pressure-fitting or another technique.

The lid member 27 is fanned with a recess 27a and a screw hole 27b located under and communicated with the recess 27a. In this recess 27a, the valve seat 26 is mounted to be movable in the axial direction. This allows the valve seat 26 in the recess 27a to move downward when the pressure acts on an upper surface of the valve seat 26. The screw hole 27b threadedly engages with an adjusting screw 28. A metal plate 29 is placed between the valve seat 26 and the adjusting screw 28. Accordingly, by rotation of the adjusting screw 28, the height position of the valve seat 26 can be adjusted through the metal plate 29. The lid member 27 is further provided with a sealing member 271 that seals the opening 7c of the body member 7.

The pressure regulating chamber 21 is sealingly closed by a lid member 23 fitted from above in a right upper end portion of the body member 7. The lid member 23 is formed with a columnar protrusion axially extending downward to restrict upward movement of the piston 24 when an upper end of the piston 24 comes into contact with the relevant protrusion. When the upper end of the piston 24 contacts with this protrusion, an annular space is generated in the pressure regulating chamber 21. While no pressure is applied to the pressure regulating valve 10, the upper end face of the piston 24 is in contact with a lower end face of the columnar protrusion of the lid member 23. An outlet terminal passage 61 is formed horizontally to communicate the pressure regulating chamber 21 with the outlet terminal 6.

A columnar-shaped through hole 2411 is formed through the piston 24 and the valve element 241 in their axial direction to extend from the upper end of the piston 24 to a lower end of the valve element 241. In other words, the valve element 241 has a hollow cylindrical shape extending in the axial direction. The thus shaped valve element 241 (the through hole 2411) allows fluid communication between the pressure regulating chamber 21 and the valve chamber 22 when the valve element 241 is moved away from the valve seat 26. On an outer peripheral surface of a main portion of the piston 24, there is fitted an annular sealing member 242 held in sliding contact with an inner peripheral surface defining the pressure regulating chamber 21 to seal the pressure regulating chamber 21. The annular sealing member 242 has a lip-shaped cross-section opening upward in a V shape. A lower end of the piston 24 is formed with a spring receiving seat 246 recessed to hold an upper end of the coil spring 25. The coil spring 25 is a cylindrical compression spring. A lower end of the coil spring 25 is restricted in position by a holding portion 247 integrally formed with the body member 7.

Under the holding portion 247, an annular sealing member 243 is fitted in sliding contact with an outer peripheral surface of the valve element 241 to seal the valve chamber 22. The annular sealing member 243 has a lip-shaped cross-section opening downward in a V shape (toward the valve chamber). Under the annular sealing member 243, a bearing portion 245 is installed to guide axial movement (upward and downward movement) of the valve element 24. The bearing portion 245 is made of resin and thus can provide good sliding performance, so that the bearing portion 245 can be prevented becoming worn. Such a bearing portion 245 can reliably guide the valve element 241 for a long term. This bearing portion 245 being placed under the annular sealing member 243 can also serve to prevent dropping of the annular sealing member 243. It is therefore possible to prevent leakage from the annular sealing member 243.

Herein, setting of a pressure regulating value of the pressure regulating valve 10 (final pressure of the pressure regulating chamber 21) will be explained. This setting of a pressure regulating value is performed as below. In a manufacturing facility, the pressure of a pressure regulating value is applied to the valve chamber 22 (the pressure regulating chamber 21) to bring the pressure acting on the piston 24 in balance with the spring force of the coil spring 25. Specifically, the upper end of the piston 24 is held out of contact with the columnar protrusion of the valve seat 23 and the valve element 241 is held out of contact with the valve seat 26. In this state, the valve seat 26 is moved by operation of the adjusting screw 28 to a target position to come into contact with the valve element 241. Accordingly, when the pressure of the pressure regulating chamber 21 is the pressure regulating value, the valve element 241 is in contact with the valve seat 26, thereby interrupting communication between the valve chamber 22 and the pressure regulating chamber 21. On the other hand, when the pressure of the pressure regulating chamber 21 becomes smaller than the pressure regulating value, the piston 24 is moved upward and the valve element 241 is separated from the valve seat 26, thereby allowing communication between the valve chamber 22 and the pressure regulating chamber 21. Thus, the pressure of the pressure regulating chamber 21 can be kept at the pressure regulating value.

When the valve seat 26 is being moved by operation of the adjusting screw 28, the valve seat 26 receives a pressure difference (a pressure difference between the pressure of the pressure regulating value (e.g., the pressure of the valve chamber 22) and the atmospheric pressure (e.g., the outside air pressure applied to the valve seat 26 through the screw hole 27b)). In the present embodiment, however, the bearing portion 245 prevents the rod-like valve element 241 from tilting and therefore the valve seat 26 can be designed to be small (with a small valve seat diameter). The valve seat 26 can thus have a reduced pressure-receiving area. Consequently, when the pressure regulating value is to be set, the pressure difference acting on the valve seat 26 is small at the time of adjusting the position of the valve seat 26, so that adjusting the position of the valve seat 26 by use of the adjusting screw 28 can be performed by a small force. This enables very easy setting of a pressure regulating value, resulting in improved productivity.

(Intermediate Passage)

The intermediate passage 3 includes a first intermediate passage 31 extending horizontally from the pressure regulating chamber 11 of the upstream pressure regulating valve 1, a second intermediate passage 32 extending horizontally from the valve chamber 22 of the downstream pressure regulating valve 2, and a third intermediate passage 33 extending vertically to communicate the first intermediate passage 31 with the second intermediate passage 32. The body member 7 is formed with a hole 72A used in machining the first intermediate passage 31, and a hole 72B used in machining the second intermediate passage 32. To an outer wall surface of the body member 7, sealing members 9A and 9B are respectively secured to hermetically seal the holes 72A and 72B. Above the third intermediate passage 33, there is provided the check valve 4 mentioned later. Between an entrance 42 of the check valve 4 and the third intermediate passage 33, a check-valve entrance passage 52 is formed to extend vertically to communicate the third intermediate passage 33 with the entrance 42.

(Check Valve)

The check valve 4 is an inward flow check valve and is provided with a valve chamber 41, the entrance 42 of the valve chamber 41, a ball valve 43 accommodated in the valve chamber 41 and moved into contact with or away from the entrance 42, a press spring 44 urging the ball valve 43 toward the entrance 42, a sealing member 46 holding the press spring 44 and sealing the valve chamber 41 with respect to the body member 7, and an exit 47 of the valve chamber 41. Between the exit 47 and the pressure regulating chamber 21 of the downstream pressure regulating valve 2, there is formed a check-valve exit passage 51 extending horizontally to communicate the exit 47 with the pressure regulating chamber 21. The exit passage 51 is formed coaxially with the outlet terminal passage 61.

<Operating Method of Pressure Regulating Valve>

Next, an operating method of the pressure regulating valve according to the present embodiment will be explained with reference to FIG. 1. As shown in FIG. 1, for example, when fuel gas G starts to be supplied to a vehicle fuel cell and flows out from the outlet terminal 6 in a direction indicated by arrows, the pressure of fuel gas G stored in the pressure regulating chamber 21 of the downstream pressure regulating valve 2 lowers. As the pressure of fuel gas G in the pressure regulating chamber 21 decreases, the piston 24 moves upward, allowing supply of the fuel gas G from the valve chamber 22 to the pressure regulating chamber 21 via the piston through hole 2411 formed in the piston 24 and the valve element 241. This increases the internal pressure of the pressure regulating chamber 21. When the internal pressure of the pressure regulating chamber 21 reaches a predetermined pressure, the piston 24 presses downward the spring 25, bringing the lower end of the valve element 241 into contact with the valve seat 26, thus stopping supply of the fuel gas G from the valve chamber 22.

In this way, the pressure of the pressure regulating chamber 21 is maintained at the pressure regulating value set by the adjusting screw 28 as above. The leading end of the adjusting screw 28 is in contact with the valve seat 26 through the metal plate 29. Therefore, the valve seat 26 made of resin does not directly contact with the leading end of the adjusting screw 28. This makes it possible to reliably prevent deformation of the valve seat 26. Accordingly, the position of the valve seat 26 after the pressure regulating value is set does not change, thus avoiding deviation of the pressure regulating value. This can precisely maintain the internal pressure of the pressure regulating chamber 21 at a desired pressure regulating value. According to the pressure regulating valve 10, specifically, the pressure regulating value can be very easily adjusted and further a desired pressure regulating value can be precisely achieved.

Since the valve chamber 22 of the downstream pressure regulating valve 2 and the pressure regulating chamber 11 of the upstream pressure regulating valve 1 are communicated with each other through the intermediate passages 3 (31, 32, and 33), when the pressure of fuel gas G in the valve chamber 22 lowers, the fuel gas G stored in the pressure regulating chamber 11 of the upstream pressure regulating valve 1 is allowed to flow in a direction of arrows as shown in FIG. 1 to increase the internal pressure of the valve chamber 22 of the downstream pressure regulating valve 2. At that time, the internal pressure of the pressure regulating chamber 11 of the upstream pressure regulating valve 1 is decreased, and thereby the valve element 13 of the upstream pressure regulating valve 1 is moved upward by the urging force of the coil spring 16 urging the piston 15. When the valve element 13 is moved upward and separated from the valve seat 14, the high-pressure fuel gas G supplied from a fuel tank to the inlet terminal 8 is allowed to flow in the pressure regulating chamber 11 via the inlet terminal passage 81 and the valve chamber 12. Accordingly, the pressure of the fuel gas G in the pressure regulating chamber 11 is maintained at a predetermined value (an intermediate pressure).

Herein, when supply of the fuel gas G to the fuel cell is stopped, the pressure of the fuel gas G stored in the pressure regulating chamber 21 of the downstream pressure regulating valve 2 is no longer decreased. Thus, the fuel gas G leaking from the upstream pressure regulating valve 1 into the intermediate passages 3 (31, 32, and 33) does not escape to anywhere, resulting in an increase in internal pressure of the intermediate passages 3. When the pressure of the fuel gas G in the intermediate passages 3 rises to or more than a predetermined value, the ball valve 43 of the check valve 4 moves away from the entrance 42 and thus the check valve 4 operates. At that time, the fuel gas G is released from the third intermediate passage 33 into the valve chamber 41 of the check valve 4 through the check-valve entrance passage 52. This makes it possible to avoid overload of the fuel gas G on the annular sealing member 151 sealing the pressure regulating chamber 11 of the upstream pressure regulating valve 1 and the annular sealing member 243 sealing the valve chamber 22 of the downstream pressure regulating valve 2, the chambers 11 and 22 being continuous with the intermediate passages 3 (31, 32, and 33). The fuel gas G released into the valve chamber 41 of the check valve 4 is then supplied to the outlet terminal 6 through the pressure regulating chamber 21 of the downstream pressure regulating valve 2 and the outlet terminal passage 61. This can reduce waste of the fuel gas G due to outside release.

According to the pressure regulating valve 10 in the present embodiment explained in detail above, the valve seat 26 is accommodated and held to be movable up and down in the recess 27a of the lid member 27. The position of the valve seat 26 (the contact position with the valve element 241) is adjusted by use of the adjusting screw 28 so that the valve element 241 contacts with the valve seat 26 at the time when the internal pressure of the pressure regulating chamber 21 reaches a desired pressure regulating value (final pressure). It is accordingly possible to adjust the position of the valve seat 26 by the adjusting screw 28 without moving (rotating) the lid member 27 that holds the valve seat 26. Since the sealing member 271 is not worn or deformed, the sealing performance is not deteriorated, thus enabling precise adjustment of the position of the valve seat 26 and setting of the pressure regulating value.

The foregoing embodiments are mere examples and do not give any limitations to the present invention. The present invention may be embodied in other specific forms without departing from the essential characteristics thereof.

### REFERENCE SIGNS LIST

1 Upstream pressure regulating valve
2 Downstream pressure regulating valve
7 Body member
7c Opening
10 Pressure regulating valve
21 Pressure regulating chamber
24 Piston
25 Coil spring
26 Valve seat
27 Lid member
27a Recess
27b Screw hole
28 Adjusting spring
29 Metal plate
241 Valve element
243 Annular sealing member
245 Bearing portion
271 Sealing member

What is claimed is:

1. A pressure regulating valve including:
a pressure regulating chamber;
a piston placed in the pressure regulating chamber;
a valve element to be movable in an axial direction together with the piston;
a valve chamber in which an end portion of the valve element is placed;
a valve seat member made of resin, which the valve element is brought into contact with and separated from;
an urging member urging the piston in a direction to separate the valve element from the valve seat member; and
a body member accommodating the valve element and the valve seat member,
wherein the valve element has a hollow cylindrical shape extending in the axial direction and is configured to allow communication between the valve chamber and the pressure regulating chamber when the valve element is separated from the valve seat member,
the valve seat member is arranged to be movable in the axial direction, and
an adjusting member configured to move the valve seat member to adjust a contact position with the valve element from outside.

2. The pressure regulating valve according to claim 1, further comprising:
a lid member closing an opening formed in an end portion of the body member and defining the valve chamber,
wherein the lid member includes:
a recess accommodating and holding the valve seat member moveably in the axial direction, and
a screw hole communicated with the recess and threadedly engaged with the adjusting member.

3. The pressure regulating valve according to claim 1, further comprising a metal plate between the valve seat member and the adjusting member.

4. The pressure regulating valve according to claim 1, further comprising a bearing portion to guide movement of the valve element in the axial direction.

5. The pressure regulating valve according to claim 4, wherein the bearing portion is made of resin.

6. The pressure regulating valve according to claim 4, further comprising a sealing member that is placed in sliding contact with an outer peripheral surface of the valve element and seals the valve chamber, and
wherein the bearing portion is placed on a side closer to the valve seat member than the sealing member is.
